(19) United States
(12) Patent Application Publication
(10) Pub. No.: US 2023/0140760 A1
(43) Pub. Date: May 4, 2023

(54) CONTENT CREATION SYSTEM BASED ON EXTENDED REALITY

(71) Applicant: SPACEELVIS CO., LTD., Seoul (KR)

(72) Inventors: Seung Ho LEE, Gyeonggi-do (KR); Sung Ho ZO, Seoul (KR)

(21) Appl. No.: 17/878,157

(22) Filed: Aug. 1, 2022

(30) Foreign Application Priority Data
Oct. 28, 2021 (KR) 10-2021-0145781

(51) Int. Cl. G06T 19/00; G06T 19/20; G06F 3/01

(52) U.S. Cl. CPC G06T 19/006; G06T 19/20; G06F 3/011

(57) ABSTRACT

A content creation system based on extended reality includes a floor part provided with a space in which an object including a person or a thing is positioned to be able to proceed with content, one or more wall parts configured to include displays on respective sides of the floor part and output images or videos to the displays, a camera configured to photograph the object proceeding with the content on the floor part and the wall parts, and a control server including a database in which the videos to be output to the displays configured on the wall parts are previously stored and a content video captured by the camera is stored, and a tracking part for tracking positions of the object in real time, the control server being able to control and manage the floor part, the wall parts, the camera, and the database.

### CROSS REFERENCE TO RELATED APPLICATION AND CLAIM OF PRIORITY

The application claims the benefit under 35 USC § 119 of Korean Patent Application No. 10-2021-0145781, filed Oct. 28, 2021, in the Korean Intellectual Property Office, the entire contents of which is incorporated herein for all purposes by this reference.

### BACKGROUND

### 1. Field of the Invention

The present disclosure relates to a content creation system based on extended reality. More particularly, the present disclosure relates to a content creation system based on extended reality and configured to create content based on the extended reality in a studio based on the extended reality.

### 2. Description of the Related Art

Due to the COVID-19 outbreak that occurred in late 2019 or early 2020, a situation where most people are unable to travel abroad or domestically continues. As a result, more than half of Korea's tourism industry revenue has declined compared to the revenue before the COVID-19 outbreak. The transportation and lodging industries interworking with the tourism industry are also facing a hard time when the business closure in some industries is accelerating due to a continuous decline in sales, and in order to compensate for the declining sales, the transportation industry is providing customers with photo zones.

In addition, in order to provide more realistic photo zones to a customer, displays and a smartphone are interconnected to display customer's desired background screens, and the customer takes photos towards the desired background screens, so that it is possible to provide analogous tourist attractions as if the customer were actually taking the photos at the tourist attractions displayed on the displays.

However, depending on distances between the smartphone and the displays and positions where images are captured by the smartphone, a part of the captured images detracts realism, whereby there often occurs a case in which the images photographed by the smartphone are useless.

### SUMMARY

An objective of the present disclosure is to provide a content creation system based on extended reality and configured to create content based on the extended reality in a studio based on the extended reality.

In order to solve the above problem, the content creation system based on the extended reality according to an embodiment of the present disclosure includes: a floor part provided with a space in which an object including a person or a thing is positioned to be able to proceed with content; one or more wall parts configured to include displays on respective sides of the floor part and output images or videos to the displays; a camera configured to photograph the object proceeding with the content on the floor part and the wall parts; and a control server including a database in which the videos to be output to the displays configured on the wall parts are previously stored and a content video captured by the camera is stored, and a tracking part configured to track positions of the object in real time, the control server being able to control and manage the floor part, the wall parts, the camera, and the database, wherein the control server may further include: a coordinate setting part configured to set respective fixed position coordinates of the floor part, the wall parts, and the camera; a coordinate calculation part configured to calculate position coordinates of the object; and an angle application part configured to calculate angles of the images or the videos being output from the wall parts on the basis of the coordinates calculated by the coordinate calculation part, and apply and transmit the calculated values to the wall parts.

In addition, the content creation system based on the extended reality according to the embodiment of the present disclosure may further include a motion sensing part installed at a position close to the wall parts and floor part and configured to sense action and motion of the object, wherein information on the action and the motion of the object sensed by the motion sensing part may be transmitted to the control server.

In addition, in the content creation system based on the extended reality according to the embodiment of the present disclosure, the tracking part may include a vector calculation part configured to track action or motion of the object appearing in the content video on the basis of the content video captured by the camera and calculate vector values for the action or the motion of the tracked object.

In addition, in the content creation system based on the extended reality according to the embodiment of the present disclosure, the vector values calculated by the vector calculation part may be transmitted to the angle application part to change the angles of the videos or images previously output to the wall parts in real time.

In addition, in the content creation system based on the extended reality according to the embodiment of the present disclosure, the control server may further include a floor area extraction part configured to extract an area corresponding to the floor part from the content video captured by the camera, and the control server may apply the area extracted by the floor area extraction part to the previously output images or videos to the wall parts, and extract the applied area to synthesize with the content video.

In addition, in the content creation system based on the extended reality according to the embodiment of the present disclosure, the control server may further include a content provision part configured to transmit the content video proceeded with synthesis with respect to an area extracted by a floor area extraction part to an external platform, or transmit the content video to outside through real-time streaming.

Such a solution will become more apparent from the following detailed description of the present disclosure based on the accompanying drawings.

Prior to this, the terms or words used in the present disclosure and claims are not to be construed as their ordinary and dictionary meanings, and should be interpreted as meanings and concepts corresponding to the technical spirit of the present disclosure based on the principle that inventors may properly define the concept of a term in order to best describe their disclosure.

According to an exemplary embodiment of the present disclosure, by tracking in real time for an object creating content inside a studio, display positions and angles of images or videos being output on displays may be changed in real time according to positions of the object and angles and distances of a camera. That is, the images or videos, which are displayed on the displays, may be output at optimized angles in real time according to the respective positions of the camera and the object.

In addition, according to the exemplary embodiment of the present disclosure, a content video based on extended reality may be created by integrating images output to each wall part and images synthesized into a floor part.

### BRIEF DESCRIPTION OF THE DRAWINGS

FIG. 1 is an exemplary view illustrating an overall configuration of a content creation system based on extended reality according to an exemplary embodiment of the present disclosure.

FIG. 2 is a block diagram illustrating components of a control server of the content creation system based on the extended reality according to the exemplary embodiment of the present disclosure.

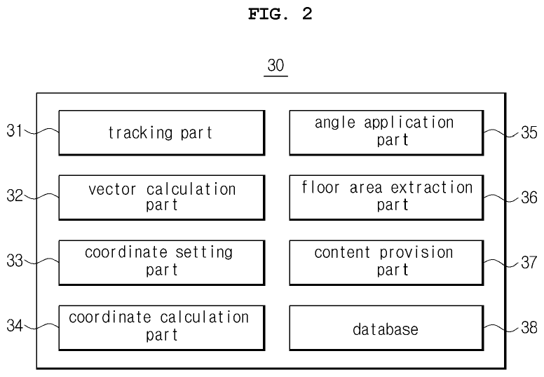

### DETAILED DESCRIPTION

The specific aspects and specific technical features of the present disclosure will become more apparent from the following detailed description and exemplary embodiments in conjunction with the accompanying drawings. In adding reference numerals to the components of each drawing, it should be noted that the same reference numerals are used to refer to the same components as much as possible even if displayed on different drawings. In addition, in the following description of the exemplary embodiment of the present disclosure, detailed descriptions of related known functions and components incorporated herein will be omitted when it is determined that the subject matter of the present disclosure may be obscured thereby.

In addition, when describing the components of the present disclosure, terms such as first, second, A, B, (a) or (b) may be used. Since these terms are provided merely for the purpose of distinguishing the components from each other, they do not limit the nature, sequence, or order of the components. When a component is described as being “connected”, “coupled”, or “linked” to another component, that component may be directly connected or connected to that other component. However, it should be understood that yet another component between each of the components may be “connected”, “coupled”, or “linked” to each other.

Hereinafter, the exemplary embodiment of the present disclosure will be described in detail on the basis of the accompanying drawings.

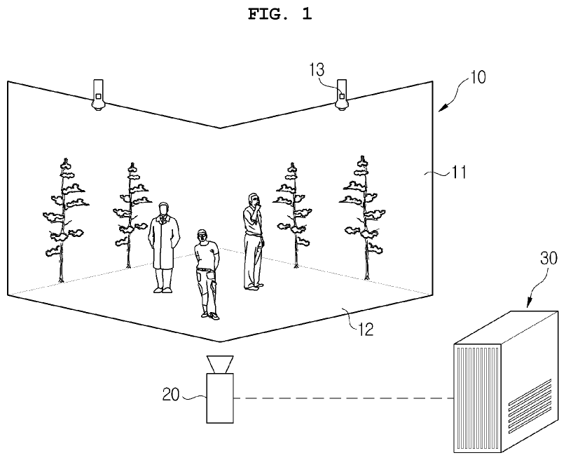

As shown in FIG. 1, a content creation system based on extended reality according to the exemplary embodiment of the present disclosure may be configured to include a studio 10, a camera 20, and a control server 30.

The studio 10 is a place provided with a space where an object including a person or a thing is positioned to proceed with content creation, and may be configured to include a floor part 12 where the object may be positioned, and a wall part 11 configured on one side of the floor part 12.

The floor part 12 is provided with the space for the object to proceed with content, and may be provided similarly to a chromakey or provided in a single color suitable for synthesizing so that other images or videos may be synthesized afterwards into an area corresponding to the floor part 12 in a content video captured by the camera.

One or more wall parts 11 are configured on one side of the floor part 12, and in the present disclosure, two wall parts 11 are configured to be vertical from the floor part 12, and may be configured to include respective displays so that images or videos may be output thereon.

That is, in the studio 10, an object may proceed with content in the space secured through each wall part 11 and the floor part 12, and the completeness of content creation may be increased by displaying images or videos required for the content on each wall part 11.

In addition, the content created in the studio 10 may be captured by the camera 20, and the captured video may be stored in a database 38.

Here, the database 38 is built in the control server 30, and may perform functions of pre-storing the images or videos to be output to the display installed on each wall part 11, and additionally storing the content video captured by the camera 20.

The control server 30 is a server that controls and manages the studio 10, the camera 20, and the database 38, and in the future, may be provided with a transmission module (not shown) built therein and configured to transmit a content video to outside, so as to stream the completed content video in real time or post the completed content video on a separate platform.

Such a control server 30 may be configured to include a tracking part 31.

The tracking part 31 performs a function of tracking positions of an object located inside the studio 10 in real time, and a tracking method thereof may be roughly divided into two types.

First, a motion sensing part 13 may be installed in the interior of the studio 10 (or at a position close to the wall parts and floor part) to detect action of an object in real time, and may track the object in real time on the basis of information on the action and motion of the detected object. The above-described method may be used when a content video is posed on a separate platform, but is not limited thereto.

Second, the tracking part 31 may track the object in real time on the basis of vector values calculated through a vector calculation part 32. Specifically, the vector calculation part 32 may track the action and motion of the object appearing in a content video on the basis of the content video captured by the camera 20, and perform a function of calculating the vector values for the action or motion of the tracked object.

The vector values calculated by the vector calculation part 32 are transmitted to an angle application part 35 to change angles relative to the videos or images previously output to each wall part 11 in real time. The above-described method may be used when the content video is streamed in real time, but is not limited thereto.

Position coordinates of an object may be calculated through a coordinate calculation part 34 on the basis of position information about the object obtained by selecting at least any one of the above-described two methods, and respective fixed position coordinates of the floor part 12, each wall part 11, and the camera 20 may be set through a coordinate setting part 33.

Thereafter, the control server 30 may be configured to further include an angle application part 35 that calculates angles of the images or videos being output from each wall part 11 on the basis of the coordinates calculated by the coordinate calculation part 34, and applies and transmits the calculated values to each wall part 11.

When the angles are transmitted to each wall part 11 on the basis of the angles calculated by the angle application part 35, each wall part 11 outputs the images or videos at the angles calculated by the angle application part 35, so that the level of content completeness may be improved when content is captured by the camera 20.

Meanwhile, the control server 30 may further include a floor area extraction part 36 configured to extract an area corresponding to the floor part 12 from the content video captured by the camera 20.

The floor area extraction part 36 may extract an area corresponding to the floor part 12 from a content video captured by the camera 20, additionally select images or videos previously output to the display installed on each wall part 11, and apply the area extracted by the floor area extraction part 36 to the selected images or videos, whereby the applied area may be separately extracted. Thereafter, the extracted area (i.e., the images or videos already output to each wall part) is synthesized with the area corresponding to the floor part 12 in the content video captured by the camera 20, whereby the content video may be created as a content video based on extended reality (XR).

The content video completed by the above method may be transmitted to an external platform through a content provision part 37 or externally transmitted through real-time streaming.

According to an exemplary embodiment of the present disclosure, by tracking in real time for the object that creates the content inside the studio, the display positions and angles of the images or videos being output on the displays may be changed in real time according to the positions of the object and the angles and distances of the camera. That is, the images or videos, which are displayed on the displays, may be output at the optimized angles in real time according to the respective positions of the camera and the object.

In addition, according to the exemplary embodiment of the present disclosure, the content video based on extended reality may be created by integrating the images output to each wall part and the images synthesized into the floor part.

Therefore, although the present disclosure has been described in detail through the exemplary embodiment, the exemplary embodiment is for describing the present disclosure in detail, and the content creation system based on the extended reality according to the present disclosure is not limited thereto. In addition, terms such as “include”, “compose”, or “have” described above mean that the corresponding component may be embedded unless otherwise stated, so it should be construed as not excluding other components, but may further include other components. All terms, including technical and scientific terms, have the same meaning as commonly understood by those skilled in the art to which the present disclosure belongs, unless otherwise defined.

In addition, although exemplary aspects of the present disclosure have been described for illustrative purposes, those skilled in the art will appreciate that various modifications, additions and substitutions are possible, without departing from essential characteristics of the present disclosure. Therefore, the exemplary embodiments disclosed in the present disclosure are not intended to limit the technical idea of the present disclosure but to describe the present disclosure, and the scope of the technical idea of the present disclosure is not limited by these exemplary embodiments. The scope of protection of the present disclosure should be interpreted by the following claims, and all technical ideas within the scope equivalent thereto should be construed as being included in the scope of the present disclosure.

What is claimed is:

1. A content creation system based on extended reality, the system comprising:
a floor part provided with a space in which an object including a person or a thing is positioned to be able to proceed with content;
one or more wall parts configured to comprise displays on respective sides of the floor part and output images or videos to the displays;
a camera configured to photograph the object proceeding with the content on the floor part and the wall parts; and
a control server comprising a database in which the videos to be output to the displays configured on the wall parts are previously stored and a content video captured by the camera is stored, and a tracking part configured to track positions of the object in real time, the control server being able to control and manage the floor part, the wall parts, the camera, and the database,
wherein the control server further comprises:
a coordinate setting part configured to set respective fixed position coordinates of the floor part, the wall parts, and the camera;
a coordinate calculation part configured to calculate position coordinates of the object; and
an angle application part configured to calculate angles of the images or the videos being output from the wall parts on the basis of the coordinates calculated by the coordinate calculation part, and apply and transmit the calculated values to the wall parts.

2. The system of claim 1, further comprising:
a motion sensing part installed at a position close to the wall parts and floor part and configured to sense action and motion of the object,
wherein information on the action and the motion of the object sensed by the motion sensing part is transmitted to the control server.

3. The system of claim 1, wherein the tracking part comprises:
a vector calculation part configured to track action or motion of the object appearing in the content video on the basis of the content video captured by the camera and calculate vector values for the action or the motion of the tracked object.

4. The system of claim 3, wherein the vector values calculated by the vector calculation part are transmitted to the angle application part to change the angles of the videos or images previously output to the wall parts in real time.

5. The system of claim 1, wherein the control server further comprises a floor area extraction part configured to extract an area corresponding to the floor part from the content video captured by the camera, and
the control server applies the area extracted by the floor area extraction part to the previously output images or videos to the wall parts, and extracts the applied area to synthesize with the content video.

6. The system of claim 1, wherein the control server further comprises:
a content provision part configured to transmit the content video proceeded with synthesis with respect to an area extracted by a floor area extraction part to an external platform, or transmit the content video to outside through real-time streaming.
